(19) United States
(12) Patent Application Publication
(10) Pub. No.: US 2022/0253413 A1
(43) Pub. Date: Aug. 11, 2022

(54) APPLICATION AND DATABASE MIGRATION TO A BLOCK CHAIN DATA LAKE SYSTEM

(71) Applicants: NewSouth Innovations Pty Limited, Sydney, New South Wales (AU); The Commonwealth of Australia represented by the Department of Defence, Edinburgh SA (AU)

(72) Inventors: Elizabeth Chang, Sydney, New South Wales (AU); Amit Ghildyal, Edinburgh SA (AU); Stuart Green, Edinburgh SA (AU)

(21) Appl. No.: 17/625,300

(22) PCT Filed: Jul. 9, 2020
(86) PCT No.: PCT/AU2020/050714

§ 371 Date: Jan. 6, 2022

(30) Foreign Application Priority Data
Jul. 9, 2019 (AU) 2019902432

(51) Int. Cl. G06F 16/21; G06F 16/28; G06F 16/22

(52) U.S. Cl. CPC G06F 16/214; G06F 16/283; G06F 16/2282; G06F 16/289

(57) ABSTRACT

A block chain data lake system comprises a data lake of a plurality of data files and software applications interfacing the data files. The system further comprises a block chain and block chain controller therefor. A transaction controller monitors transactions performed on the data files by functions of the software applications to add hashes to blocks of the block chain using the data files. A verification controller may verify data files by searching the block chain for hashes matching the data files. An authentication controller may issue cryptographic keys for software application, including specific functions thereof. A data migration system may migrate data from a legacy data system to the block chain data lake system. A synchronisation controller may synchronise data updated by software applications of the legacy data system in substantial real-time.

### FIELD OF THE INVENTION

This invention relates generally to a block chain data lake system and includes systems and techniques for migrating data and software application functionality from legacy data systems to the block chain data lake system.

### BACKGROUND OF THE INVENTION

Data source systems, such as ERP systems and the like typically comprise a plurality of relational databases, each comprising data tables of rows of data and which are related to other tables using foreign keys.

These data source systems have data integration issues which accumulate over time wherein interoperability with newly deployed software applications is either not possible or requires manual data extraction.

Furthermore, these data source systems have inherent data trust and security issues.

The present invention seeks to provide a way to overcome or substantially ameliorate at least some of the deficiencies of the prior art data source systems, or to at least provide an alternative.

It is to be understood that, if any prior art information is referred to herein, such reference does not constitute an admission that the information forms part of the common general knowledge in the art, in Australia or any other country.

### SUMMARY OF THE DISCLOSURE

According to one aspect, there is provided a system comprising: a data lake comprising a plurality of data files, including in semi-structured or unstructured data format; a software application interface for the data files, the software application interface having a plurality of software applications, each having one or more functions for performing transactions on the data files; a block chain and a blockchain controller for the block chain; a hashing controller which generates hashes; a verification controller which verifies the data files; a transaction controller which monitors transactions performed on the data files by functions of the software applications, wherein, for a transaction involving a data file: prior execution of the transaction, the verification controller is controlled by the transaction controller to:

generate a hash using the data file and the hashing controller; and to verify the data file by searching for a matching hash stored in the block chain; if the data file is verified: the transaction is executed and data within the data file is added or updated; and the transaction controller uses the hashing controller to generate a new hash using the data file; and the blockchain controller adds the new hash to a block of the block chain.

The system may further comprise a legacy data system comprising a plurality of relational databases; a data migration subsystem interfacing the legacy data system and the data lake, the data migration subsystem comprising: a database connection controller for connecting to the relational databases; a data transformation mapping specifying mapping of data of the relational databases to data of respective data files; and a data translation controller which translates the data of the relational databases to a data format for the data files.

The data transformation mapping may map columns of data tables of more than one relational database to the data of a respective data file.

The data translation controller may generate data objects using the data selected from the relational databases and serialises the data objects to data for the data files.

The data migration subsystem may comprise a synchronisation controller which periodically controls the data translation controller to synchronise data from the relational databases to the data files.

The synchronisation controller may be responsive to updating of data of the relational databases.

The synchronisation controller may comprise a trigger controller which detects updating of data of a row of a column of a relational database specified by the data transformation mapping.

The legacy data system may have software applications interfacing the relational databases and wherein the software applications interfacing the relational databases and the software applications of the software application interface operate simultaneously and wherein the synchronisation controller continuously updates data of the data files with data from the relational databases updated by the software applications interfacing the relational databases.

Each software application may be associated with a single respective data file.

Each data file may store all data required for all functions of each respective software application.

The system may further comprise an elastic search engine which indexes the data files an generates an index and wherein the software applications search for data objects using the index.

The search index may be a keyword search index.

The system may further comprise a public/private key cryptography authentication controller which issues keys for the control of specific software applications.

The system may further comprise a public/private key cryptography authentication controller which issues keys for the control of specific functions of the software applications.

The verification controller may search the block chain in reverse chronological order for the matching hash.

The data lake may be a plurality of data lakes replicated across servers and wherein the system may further comprise a data file replication controller which replicates data across the replicated data lakes.

If the data file may be not verified, the transaction controller may cause the data file replication controller to synchronise data between data files of the plurality of replicated data lakes.

The system may further comprise a block chain search engine which indexes the block chain to generate a block chain search index and wherein the verification controller searches the index when verifying data files.

The block chain search index may comprise a data file ID uniquely identifying a respective data file and a block chain ID uniquely identifying a respective block within the block chain.

The block chain search index may comprise a hash offset uniquely identifying a hash within a block.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a block chain data lake system in accordance with an embodiment;

FIG. 2 shows a block chain data lake computing system in accordance with an embodiment;

FIG. 3 illustrates migrating data and software application functionality from a legacy data system to the block chain data lake system in accordance with an embodiment;

FIG. 4 illustrates performing software application function transactions using the block chain data lake system in accordance with an embodiment;

FIG. 5 illustrates synchronising data between a legacy data system and the block chain data lake system in accordance with an embodiment; and

FIG. 6 illustrates a block chain of the block chain data lake system in further detail and a search index therefore in accordance with an embodiment.

### DESCRIPTION OF EMBODIMENTS

A system 100 comprises a block chain data lake system 101 comprising a data lake 102.

The data lake 103 is repository of data stored in raw format, such as object blobs or a plurality of data files 103 therein. A data lake 103 is generally a single store of enterprise data including raw copies of source system data and transformed data used for service specific tasks such as reporting, visualization, advanced analytics, machine learning and the like. The data files 103 can include structured data from relational databases (rows and columns), semi-structured data (CSV, logs, XML, JSON), unstructured data (emails, documents, PDFs), binary data (images, audio, video) and the like.

The block chain data lake system 101 comprises an application interface 104 comprising a plurality of software applications 105 interfacing the data lake 102. The software applications 105 are accessed by user terminals 106 across the wide area network 107. The software applications 105 are preferably designed to be service specific.

The software applications 105 have functions which perform transactions on data within the data files 103.

The block chain data lake system 101 comprises a transaction controller 108 which monitors transactions performed on the data files 103 by the software applications 105.

The block chain data lake system 101 comprises a hashing controller 109 controlled by the transaction controller 108 which generates hashes 110 using the data files 103 when transactions are performed on the data files 103 by the software applications 105. The hashing controller 109 may generate a hash of an entire data file 103 using a one-way hash function such as SHA-1 (Secure Hash Algorithm 1) or the like.

The block chain data lake 101 further comprises a block chain 113. The block chain 113 may be a private block chain. The block chain 113 may be replicated across servers, each server comprising a copy of the block chain 113 which is updated in response to receipt of broadcasts from the other servers.

The block chain data lake system 101 further comprises a block chain controller 111 which adds blocks 112 comprising the hashes 110 to the block chain 113.

The block chain data lake system 101 may further comprise a block chain search engine 172 which indexes the block chain 113 to build a block chain search index 171.

The software applications 105 may include smart contracts which execute, control or document legally relevant events and actions according to transactions of the block chain 113.

The block chain data lake system 101 may further comprise a verification controller 114. Prior transactions being executed by the software applications 105, the verification controller 114 may verify the data integrity of the data files 103 by the hashes 110 of the block chain 113.

The block chain data lake system 101 may further comprise an authentication controller 115 controlling access to the software applications 105.

The authentication controller 115 may control authentication with public/private key cryptography wherein keys are issued to respective user terminals 106 and used to gain access the software applications 105. In one embodiment, each software application 105 requires an appropriate key to access specific functions thereof. In alternative embodiments, each function of each software application 105 may require a key. Types of keys may be issued for controlling read/write permissions for the data files 103.

The block chain data lake system 101 may further comprise an elastic search engine 122 which is an analytics engine for the various types of data of the data files 103, including textual, numerical, geospatial, structured, and unstructured data. The elastic search engine 122 may build a search index 123 using unstructured data of the data files 103.

In embodiments, the data lake 102 may be replicated across servers. In accordance with this embodiment, the block chain data lake system 101 may further comprise a data file application controller 115 which replicates the data files 103 between the synchronised data lakes 102.

The system 100 may further comprise a data migration subsystem 116 interfacing a legacy data system 117 comprising a plurality of relational databases 118 and the block chain data lake system 101.

The data migration subsystem 116 may comprise a database connection controller 120 which connects to the relational databases 118 to obtain data therefrom.

The data migration subsystem 116 may further comprise a data transformation mapping 120 which maps data from the relational databases 116 to the data files 103.

The data transformation mapping 120 may map columns of data tables of the relational databases 116 to the data files 103. For example, a data transformation mapping 120 may map three columns from a first data table and five columns from a second data table of a first relational database 118 and one column of a third data table of a second relational database 118 to a data file 103.

The data migration subsystem 160 may further comprise a data translation controller 121 which translates data from the relational databases 118 into a format for the data files 103. The data translation controller 121 may serialise data from rows of data tables of the relational databases 118.

The data migration subsystem 116 may comprise a synchronisation controller 125 which periodically controls the data translation controller 121 to update data of the data files 103 with data from the relational databases 118.

The data migration subsystem 116 may further comprise a trigger controller 124 which detects updating of data within the relational databases 118 and which controls the synchronisation controller 125 accordingly.

The legacy data system 117 may further comprise software applications 126 interfacing the relational databases 118.

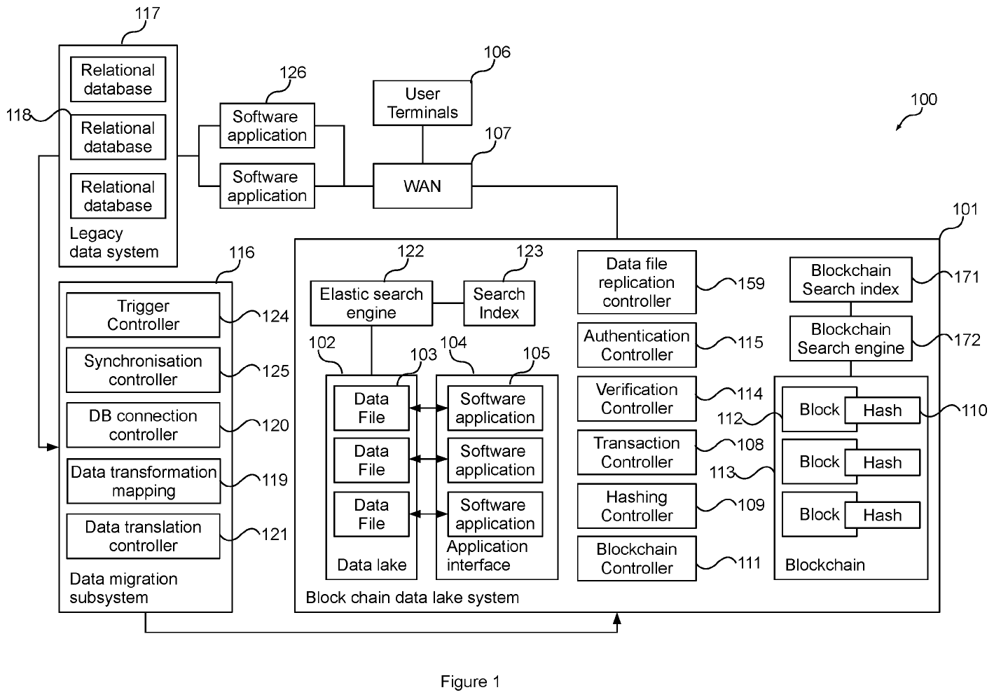

As illustrated in FIG. 1, users may use the user terminals 108 to utilise the software applications 105 of the block chain data lake system 101 and the software applications 126 of the legacy data system 117 simultaneously wherein data updated by the software applications 126 of the legacy data system 117 is synchronised periodically or in substantial real-time to the data files 103 by the data migration subsystem 116.

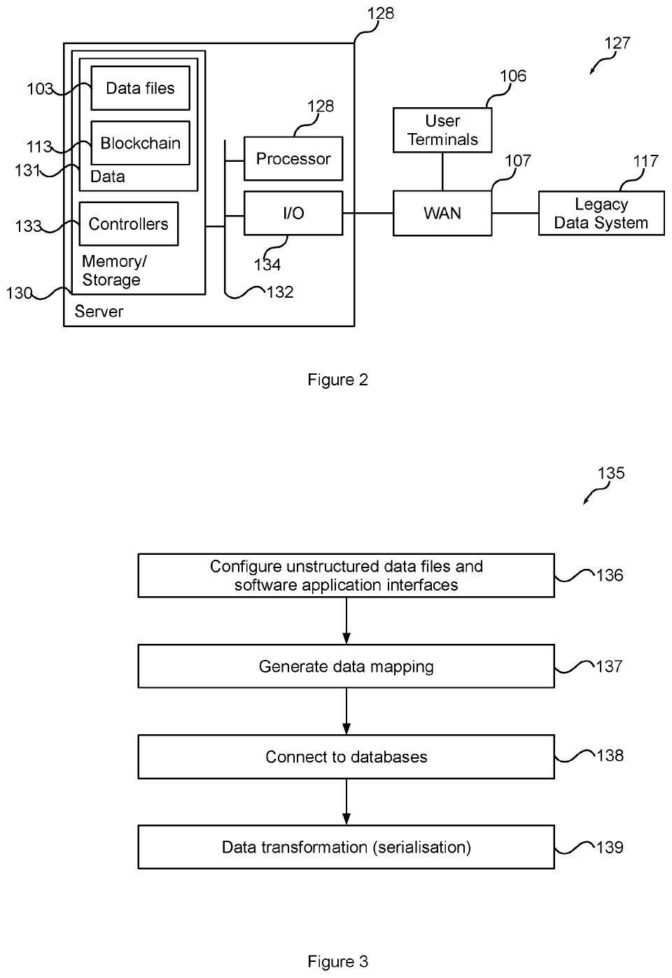

FIG. 2 shows a computer system 107 comprising a server 128 or similar computing device comprising a processor 129 for processing digital data. A memory/storage device 130 is in operable communication with the processor 129 across a system bus 132. The storage device 130 is configured for storing digital data including computer program code instructions and associated data 131. In use, the processor 129 fetches, decodes and executes these computer program code instructions and associated data 131 for implementing the functionality described herein. The computer program code instructions may be logically divided into a plurality of controllers 133 including those described herein. The data 131 may comprise the block chain 113 and the data files 103.

The server 128 may comprise an I/O interface 134 for sending and receiving data across the wide area network 107. As shown, the server 128 may be in operable communication with the legacy data system 117 across the wide area network 107 and the plurality of user terminals 106.

FIG. 3 shows a method 135 to migrate data from the legacy data system 117 to the block chain data lake system 101.

The method 135 comprises step 136 wherein the data file 103 and software applications 105 are configured. Whereas the relational databases 118 of the legacy data system 117 may be departmentally or operationally specific, such as by comprising relational databases for finance, resources and the like, the data file 103 and software applications 105 may be generated to be service specific. For example, a software application 105 and associated data file 103 may be generated for processing invoices.

In a preferred embodiment, each software application 105 has one respective data file 103 and wherein the data file 103 comprises all of the data required for all of the functions of the software application 105 to avoid having to read more than one data file 103 when performing transactions.

The method 135 may further comprise step 137 wherein the data transformation mapping 119 is generated. As alluded to above, the data transformation mapping 119 maps data from the relational databases 118 to the data files 103.

For example, for the aforedescribed invoicing software application example, a data transformation mapping 118 may be generated which maps required columns from the finance and HR databases 118 to a data file 103 used by the software application 105 for controlling invoices.

The method 135 may comprise connecting to the relational databases 118 using the database connection controller 120 at step 138 and selecting data therefrom.

Step 139 comprises data translation wherein the data translation controller 121 translates the data from the relational databases 118 specified by the data transformation mapping 119 to the data format of the data files 103.

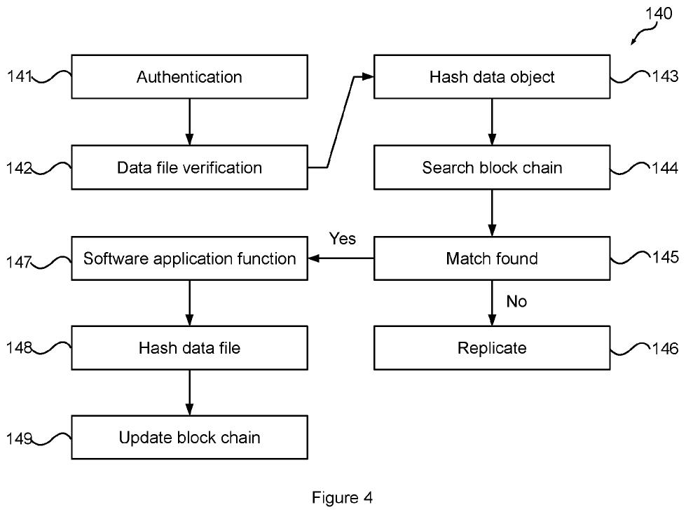

FIG. 4 illustrates a method 140 for performing transactions on the data of the data file 103 using the software applications 105.

The method 140 may comprise authentication 141 wherein a user terminal 106 is authenticated with a software application 105 or subset functions thereof using an appropriate cryptographic key.

The method 140 may comprise data file verification 142 wherein the verification controller 114 verifies the integrity of data file 103 using the hashes 110 of the block chain 113. The verification controller 114 may use the hashing controller 109 to hash a data file 103 at step 143 and then search the block chain at step 144 to determine if the block chain 113 comprises a block 112 comprising a hash 110 matching the generated hash. The verification controller 114 may use the block chain search engine 172 to search the block chain search index 171.

If a match is found by the verification controller 114 at step 145, the data file 103 is verified as being authentic and up-to-date.

Failure to find a hash within the block chain 130 may indicate that the data file 103 is out of date. In response, the data file replication controller 115 may synchronise data between distributed data lakes 102 (if any) to update the relevant data file 103 at step 146.

At step 147, the transaction of the software application function may be executed. For example, data may be added to a data file 103 or data therein updated.

After the completion of the transaction, the transaction controller 108 may cause the transaction controller 109 to hash the data within the data file 103 at step 148 and cause the block chain controller 111 to add a block 112 to the block chain comprising the hash 110 at step 149.

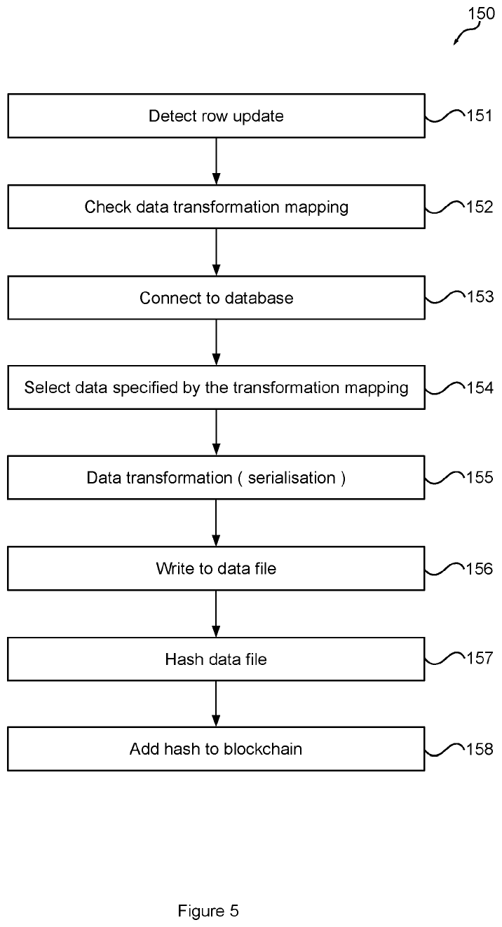

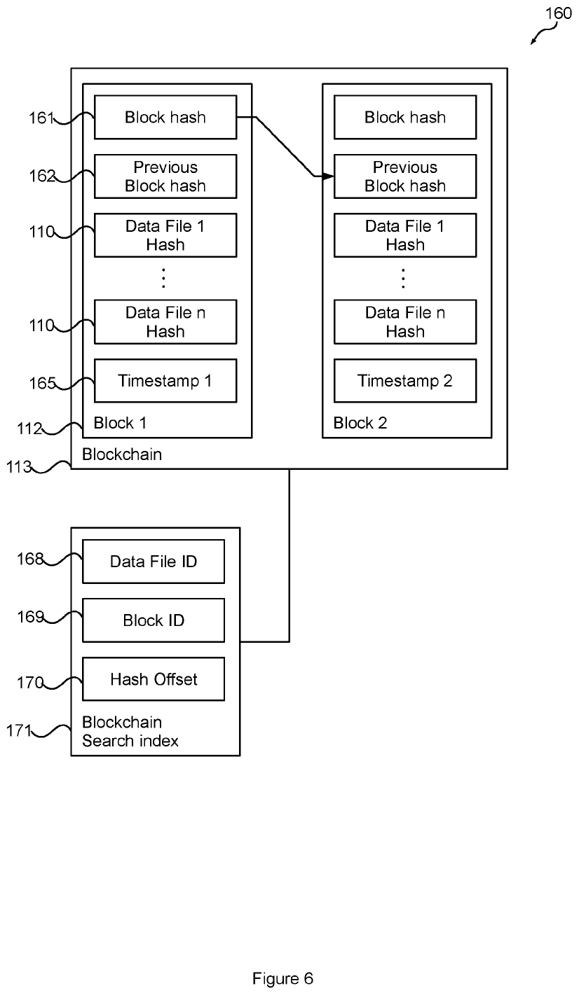

FIG. 5 shows a method 150 for synchronising data between the legacy data system 117 and the block chain data lake system 101.

At step 151, the trigger controller 124 may detect the updating of a row of an associated column of a data table of a relational database 116. The trigger controller 124 may cause the synchronisation controller 125 to use the data translation controller 121 to check the data transformation mapping 118 to determine whether a mapping exists between the affected column and at least one data file 103 at step 152.

If such mapping exists, the data connection controller 120 may connect to the relevant relational database 118 at step 153 and select data therefrom specified by the data transformation mapping 119 at step 154.

At step 155, the data is transformed into a data format (such as by data object sterilisation) required by the associated data file 103 (which may be specified by the data transformation mapping 119) and, at step 156, the data is written to the associated data file 103.

At step 157, the transaction controller 108 may detect the updating of the data file 103 and hash the data file using the hashing controller 109 and cause the block chain controller 111 to add a block 112 to the block chain comprising the hash at step 157.

FIG. 7 illustrates the block chain 112 and block chain search index 171 in further detail.

The block chain 113 comprises a plurality of blocks 112 which are added to the block chain 113 in series. Each block 112 may be hashed to a block hash 161 and each block 112 may comprise a previous block hash 162.

Each block 112 may comprise one or more data file hashes 110. Each block 112 may comprise a timestamp 165.

When verified the data file 103, the verification controller 114 may search for matching hashes 110 within the block chain 113. The verification controller 114 may search the blocks 112 in reverse chronological order until finding the first hash 112 related to the data file 103. In this regard, the block 112 may comprise an index, representing a data file ID 103 or the like which may be used to associate the hash 110 stored therein with the relevant data file 103.

However, in a preferred embodiment, the block chain search engine 172 builds the block chain search index 171.

The index 171 may comprise a data file ID 168 or the like which may be used to uniquely identify a data file 103. Furthermore, the index 171 may comprise a block ID 169 or the like used to uniquely identify a block 112 within the block chain 113.

As such, when determining the validity of a data file 103, the verification controller 114 may query the block chain search engine 171 with the idea of the relevant data file 103 and obtain the most recent block ID 169 therefrom. The verification controller 140 may then inspect the identified block 112 to obtain the data file hash 110 therefrom for comparison.

In embodiments, each block condition 12 may comprise a plurality of data file hashes 110 therein. In this regard the block chain search engine 171 may comprise a hash offset 170 specifying which data file hash 110 therein matches the data file ID 168. For example, for a particular data file 103, the hash offset 170 may specify that the associated hash 110 thereof is in the third offset.

A specific example will now be described wherein data and software application functionality for processing invoices is migrated from a legacy data system 117. It should be appreciated that this example is exemplary only and that no limitations should be necessarily imputed on the scope of the present invention accordingly.

The legacy data system 117 may comprise a finance relational database 118 comprising a data table comprising rows representing each invoice, including the name of a person who generated each invoice. The finance relational database 118 may further comprise a related invoice line item data table comprising rows representing each line item of each invoice.

The legacy data system 117 may further comprise an HR relational database 118 comprising an employee data table comprising rows representing each employee of an organisation including a position.

A legacy finance department software application 126 may allow the controlling of invoices wherein, for the generation of an invoice, the legacy finance department software application 126 firstly refers to the HR database 118 to determine whether an authenticated user has permission to generate invoices wherein, if so, the software application 126 then generates an invoice and updates the finance database 118 accordingly.

As such, migration to the block chain data lake system 101 comprises generating a data file 103 for and invoicing specific software application 105.

The data file 103 may comprise unstructured text data wherein invoices are serialised to separate lines of the text file. Adding a new invoice may comprise appending a new line to the data file 103.

A data transformation mapping 119 is generated which maps the relevant columns from the finance and HR relational databases 118 to a format of the invoicing data file 103.

For example, the data transformation mapping 119 may specify that columns including invoice reference number, payer and payee are to be mapped from the finance relational database 118 and that columns including authorised user and position be mapped from the HR relational database 118.

The data translation controller 121 may select this data from the finance and HR relational databases 118 using the data connection controller 120 and convert the data to the appropriate format for the invoicing data file 103.

For example, the data translation controller 131 may generate an invoice object for each invoice pulled from the finance database 118 and serialise each invoice object to the data file 103. The invoicing software application 105 may unserialise the data into object format when required for use.

Serialised data from each invoice may be appended to the invoicing data file 103 as a new line of text.

The elastic search engine 122 may update the search index 123 using the serialised data added to the invoicing data file 103. For example, the elastic search engine 122 may index keywords of each line of text of the invoicing data file 103.

The invoicing software application 105 is configured to provide invoicing functionality, including adding, updating, deleting, updating payment status and the like.

When a user wishes to mark and invoice as paid, the user uses the user terminal 106 to authenticate with the invoicing software application 105 using the provided cryptographic key which is verified by the authentication controller 115.

The user may then use the elastic search engine 122 to search the index 123 by invoice reference number which identifies the appropriate line of text of the invoicing data file 103.

The invoicing software application 105 may then unserialise the row into object format.

Prior updating the object, the verification controller 114 may use the hashing controller 109 to hash the data file 103 to verify the authenticity and accuracy thereof. In alternative embodiments, the verification controller 114 may hash the retrieved line of text from the data file 103 to verify the specific invoice.

The verification controller 114 may search the block chain search index 171 using a data file ID 168 of the invoicing data file 103 and retrieve a data file hash 110 from the block chain 130 and specified by the block ID 169 (and hash offset 170 if relevant) of the block chain search index 171.

If a matching hash is not found within the block chain 113, the software application 105 may display a data error. Furthermore, the data file replication controller 115 may be controlled to pull update data from replicated data lakes 102, (if any) and reattempt the verification thereafter.

The invoicing software application 105 may then be used to update the payment status of the invoice object to paid.

The invoicing object may then be serialised back to the invoicing data file 103 wherein the serialised data overwrites the relevant line.

After updating the data file 103, the transaction controller 108 may hash the data file 103 using the hashing controller 109 and cause the block chain controller 111 to add a block 112 to the block chain 113 comprising the generated hash 110.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

The term “approximately” or similar as used herein should be construed as being within 10% of the value stated unless otherwise indicated.

1. A system comprising:
a data lake comprising a plurality of data files, including in semi-structured or unstructured data format;
a software application interface for the data files, the software application interface having a plurality of software applications, each having one or more functions for performing transactions on the data files;
a block chain and a blockchain controller for the block chain;
a hashing controller which generates hashes;
a verification controller which verifies the data files;
a transaction controller which monitors transactions performed on the data files by functions of the software applications, wherein, for a transaction involving a data file:
prior execution of the transaction, the verification controller is controlled by the transaction controller to:
generate a hash using the data file and the hashing controller; and
to verify the data file by searching for a matching hash stored in the block chain;
if the data file is verified:
the transaction is executed and data within the data file is added or updated; and
the transaction controller uses the hashing controller to generate a new hash using the data file; and
the blockchain controller adds the new hash to a block of the block chain.

2. The system as claimed in claim 1, wherein the system further comprises:
a legacy data system comprising a plurality of relational databases;
a data migration subsystem interfacing the legacy data system and the data lake, the data migration subsystem comprising:
a database connection controller for connecting to the relational databases;
a data transformation mapping specifying mapping of data of the relational databases to data of respective data files; and
a data translation controller which translates the data of the relational databases to a data format for the data files.

3. The system as claimed in claim 2, wherein the data transformation mapping maps columns of data tables of more than one relational database to the data of a respective data file.

4. The system as claimed in claim 2, wherein the data translation controller generates data objects using the data selected from the relational databases and serialises the data objects to data for the data files.

5. The system as claimed in claim 2, wherein the data migration subsystem comprises a synchronisation controller which periodically controls the data translation controller to synchronise data from the relational databases to the data files.

6. The system as claimed in claim 5, wherein the synchronisation controller is responsive to updating of data of the relational databases.

7. The system as claimed in claim 6, wherein the synchronisation controller comprises a trigger controller which detects updating of data of a row of a column of a relational database specified by the data transformation mapping.

8. The system as claimed in claim 5, wherein the legacy data system has software applications interfacing the relational databases and wherein the software applications interfacing the relational databases and the software applications of the software application interface operate simultaneously and wherein the synchronisation controller continuously updates data of the data files with data from the relational databases updated by the software applications interfacing the relational databases.

9. The system as claimed in claim 1, wherein each software application is associated with a single respective data file.

10. The system as claimed in claim 9, wherein each data file stores all data required for all functions of each respective software application.

11. The system as claimed in claim 1, further comprising an elastic search engine which indexes the data files an generates an index and wherein the software applications search for data objects using the index.

12. The system as claimed in claim 11, wherein the search index is a keyword search index.

13. The system as claimed in claim 1, further comprising a public/private key cryptography authentication controller which issues keys for the control of specific software applications.

14. The system as claimed in claim 1, further comprising a public/private key cryptography authentication controller which issues keys for the control of specific functions of the software applications.

15. The system as claimed in claim 1, wherein the verification controller searches the block chain in reverse chronological order for the matching hash.

16. The system as claimed in claim 1, wherein the data lake is a plurality of data lakes replicated across servers and wherein the system further comprises a data file replication controller which replicates data across the replicated data lakes.

17. The system as claimed in claim 16, wherein, if the data file is not verified, the transaction controller causes the data file replication controller to synchronise data between data files of the plurality of replicated data lakes.

18. The system as claimed in claim 1, further comprising a block chain search engine which indexes the block chain to generate a block chain search index and wherein the verification controller searches the index when verifying data files.

19. The system as claimed in claim 18, wherein the block chain search index comprises a data file ID uniquely identifying a respective data file and a block chain ID uniquely identifying a respective block within the block chain.

20. The system as claimed in claim 18, wherein the block chain search index comprises a hash offset uniquely identifying a hash within a block.
